(19) United States
(12) Patent Application Publication
(10) Pub. No.: US 2008/0259754 A1
(43) Pub. Date: Oct. 23, 2008

(54) Recorder, Host Device, Recording Method, Instruction Method, Program, Integrated Circuit, Reproducing Device, Reproducing Method and Write-Once-Read-Many Recording Medium

(75) Inventors: Tadashi Nakamura, Nara (JP); Yoshiho Gotoh, Osaka (JP)

Correspondence Address: SNELL & WILMER L.L.P. (Matsushita), 600 ANTON BOULEVARD, SUITE 1400, COSTA MESA, CA, 92626, US

(73) Assignee: MATSUSHITA ELECTRIC INDUSTRIAL CO., LTD., Osaka (JP)

(21) Appl. No.: 10/599,239

(22) PCT Filed: Mar. 22, 2005
(86) PCT No.: PCT/JP2005/005172

§ 371 Date: Jul. 8, 2008

(30) Foreign Application Priority Data
Mar. 23, 2004 (JP) 2004-085820

(51) Int. Cl. G11B 7/00

(52) U.S. Cl. 369/47.15

(57) ABSTRACT

A recording apparatus for recording information on a write-once recording medium, the write-once recording medium including a disk management information area and a volume space, the recording apparatus including: a host apparatus; and a drive apparatus, the host apparatus including: a first instruction section for instructing the drive apparatus to allocate at least one first track and at least one second track to the volume space; a second instruction section for instructing the drive apparatus to record a file on the at least one first track; a third instruction section for instructing the drive apparatus to record a file structure on the at least one second track, the file structure managing the file; a fourth instruction section for instructing the drive apparatus to record a virtual allocation table structure in the volume space, the virtual allocation table structure managing a recording location of the file structure; and a fifth instruction section for instructing the drive apparatus to record track management information in the disk management information area, the track management information managing the at least one first track and the at least one second track, the drive apparatus including: a head section; and a control section.

### TECHNICAL FIELD

The present invention relates to: a recording apparatus for recording information on a write-once recording medium; a host apparatus included in the recording apparatus; a recording method for recording the information on the write-once recording medium; an instruction method executed by the host apparatus provided in the recording apparatus for recording the information on the write-once recording medium; a program for executing a recording procedure; an integrated circuit provided in the recording apparatus for recording the information on the write-once recording medium; a reproduction apparatus for reproducing the information from the write-once recording medium; a reproduction method for reproducing the information from the host apparatus and write-once recording medium included in the reproduction apparatus; and a program and a write-once recording medium for executing a reproduction procedure.

### BACKGROUND ART

In recent years, various forms of information recording media have been used for recording digital data. Among others, write-once optical dicks are gaining wide use although data can be recorded only once, since the cost thereof is inexpensive.

Examples of such optical dicks include CD-R dicks and DVD-R dicks. Several methods for incrementally recording data on CD-R dicks or DVD-R dicks have been proposed (see, for example, Reference 1). The methods for incrementally recording data may be, for example, a VAT (Virtual Allocation Table) method, or a multiborder (multisession) method.

Operations for recording/reproducing digital data on/from DVD-R dicks using the VAT method or multiborder method will be described.

Now, incrementally recording method using VAT will be described below with reference to the drawings. Herein, an operation of recording a file and directory tree structure shown in FIG. 13 on an information recording medium and a data structure which is formed as a result thereof when an example of the recording information medium is a DVD-R click will be described in order.

First, a format process will be described with reference to FIG. 14. FIG. 14 is shows data on a DVD-R click immediately after the format process is performed wherein the DVD-R is an example of a conventional information recording medium 10100.

A DVD-R click is an information recording medium defined by the DVD-R physical specification.

Further, files are recorded by using a volume file structure defined by the DVD-R file system specification. The DVD-R file system specification conforms to the ISO/IEC 13346 standard or the UDF (Universal Disk Format) specification. The description will be made below using the structure defined by the UDF specification.

As shown in FIG. 14, a data area of the information recording medium 10100 includes a lead-in area 10101 and a volume space 10109. The volume space 10109 includes a volume structure area 10410, a file structure/file area 10420 and a VAT (Virtual Allocation Table) structure area 10430.

In the volume structure area 10410, a volume structure defined by the UDF specification is to be recorded. In detail, the volume structure area 10410 includes an NSR descriptor, a primary volume descriptor, an implementation use volume descriptor, a partition descriptor, a logical volume descriptor, an unallocated space descriptor, a terminating descriptor, a logical volume integrity descriptor and an anchor volume descriptor pointer.

In the file structure/file area 10420, a file set descriptor 10421 and an FE (ROOT) 10422, which is a file entry of a ROOT directory file, are recorded. The FE (ROOT) 10422 is an origin of a directory tree in a partition space.

The file entry (hereinafter, referred to as FE) has a data structure defined by the UDF specification for managing the location and the size of the files to be recorded in the volume space. Herein, in order to simplify the description, the ROOT directory file is assumed to be recorded in the FE (ROOT) 10422.

In the VAT structure area 10430, a VAT 10431 and a VAT ICB 10432 are recorded. The VAT is a data structure defined by the UDF specification for the purpose of simplifying a process of updating the file structure in the write-once recording medium.

When the VAT is used, a recording location of the file structure data such as FE in the volume space is specified using virtual address in a virtual address space. VAT holds a correspondence between a logical address, which is a recording location in a logical address space on the information recording medium, and the virtual address. With such a structure, data can be rewritten virtually even in an information recording medium which is not rewritable, such as a DVD-R click. The recording location of the VAT on the information recording medium is specified by VAT ICB allocated to a last sector of an area on which data is recorded on the information recording medium.

Further, the lead-in area 10101 includes a physical format information area 10104. In the physical format information area 10104, physical format information is recorded for recording management information of various areas allocated to the information recording medium 10100. The management information may be, for example, address information of a border-out area or the like. Immediately after the format process is performed, only an area of the physical format information area 10104 is secured, and data is not recorded yet in the area.

With reference to FIG. 15, a procedure for recording directory (Dir-A) and data file (File-a) of the file and directory structure shown in FIG. 13 will be described.

When a process of recording the directory (Dir-A) and data file (File-a) on the information recording medium 10100 shown in FIG. 14 is performed, a data file (File-a) 10501, a FE (File-a) 10502, a FE (Dir-A) 10503 and FE (ROOT) 10504 are recorded in the file structure/file area 10500 as shown in FIG. 15. In this example, the directory file is included in the FE (Dir-A) 10503.

In the VAT structure area 10520, a VAT 10521, to which the newly-recorded FE 10502, FE 10503 and FE 10504 are registered, and a VAT ICB 10522 are recorded.

When a closing process is performed, first, predetermined data is recorded in the border-out area 10530 except for a next border marker 10531. Further, predetermined data is recorded in the physical format information area 10104 in the lead-in area 10101 which has remained unrecorded after the format process.

The closing process is performed so as to allow the information reproduction apparatus to search for the latest volume file structure.

When such file recording process and closing process is performed for the information recording medium 10100 having the data structure after the format process as shown in FIG. 14, the data structure as shown in FIG. 15 is formed in the information recording medium 10100.

With reference to FIG. 16, a recording procedure for a directory (Dir-B) and a data file (File-b) of the file and directory structure shown in FIG. 13 will be described.

Herein, the data file (File-b) 10601 and the file structure related thereto, i.e., a file (File-b) 10601, a FE (File-b) 10602, a FE (Dir-B) 10603 and a FE (ROOT) 10604 are recorded in the file structure/file area 10600.

In a VAT structure area 106100, the latest VAT structure, i.e., a VAT 106101 and a VAT ICB 10602 are recorded.

At last, by performing the closing process again, predetermined data is recorded in a border-out area 106200 except for a next border marker 106201. Further, the next border marker 10531 allocated in the border-out area 10530, and a border-in area 106300 including the physical format information area 106301 are recorded.

When such file recording process and closing process are performed for the information recording medium 10100 having the data structure shown in FIG. 15, the data structure as shown in FIG. 16 is formed on the information recording medium 10100.

As described above, each time the closing process is performed, an area interposed between the lead-in area 10101 or the border-in area of the volume space 10109 and the border-out area is formed. Hereinafter, such an area is called a bordered area. For example, in FIG. 16, there are bordered area #1 10700 and the bordered area #2 10701. The bordered area is a concept similar to a session in a CD-R click.

Next, with reference to a flowchart for a reproduction procedure shown in FIG. 17, a reproduction operation of a file will be described. Herein, an operation of reproducing the data file (File-a) 10501 will be described as an example.

First, data in the physical format information area 10104 in the lead-in area 10101 is reproduced, and the physical format information is obtained (step S11101).

Next, data of the next border marker is reproduced (step S11102).

The physical format information obtained in step S11101 (or step S11103) includes address information of the border-out area. Since the data of the next border marker is recorded at the predetermined location of the border-out area, the next border marker is reproduced from the location.

For example, in FIG. 16, the physical format information area 10104 includes address information of the border-out area 10530. Further, the physical format area 106301 included in the border-in area 106300 includes address information of the border-out area 106200.

When the next border marker included in physical format information obtained in step S11101 (or step S11103) has been already recorded, there is a newer bordered area. Thus, step S11103 and the following steps are performed.

In accordance with the address information of the border-in area included in the physical format information obtained in step S11101, information recorded in the next border-in area is reproduced (step S11103). The address information of the border-in area included in the physical format information can also be obtained in step S11104. From the reproduced border-in area, the physical format information is obtained.

On the other hand, when the next border marker reproduced in step S11102 remains unrecorded, the current bordered area is the latest one. Thus, step S11104 and the following steps are performed.

When it reaches the latest bordered area, with reference to the latest obtained physical format information, an end physical address of the area which is accessible is obtained (step S11104).

In FIG. 16, the end of the bordered area #2 10701 is the end of the accessible area.

Then, at last, file reproduction is performed as follows.

Information recorded in the volume structure area 10410 is reproduced first (step S11105). The reproduced information (volume structure) includes address information of file set descriptor 10421 and partition starting location. When the VAT method is employed, a virtual partition map defined by the UDF specification is included in the volume structure. Thus, based on the information, it is recognized that the VAT structure is recorded in the volume space.

The VAT ICB 106102 recorded at the end of the accessible area is reproduced (step S11106).

VAT recording location information is obtained from the read out VAT ICBP 106102, and the VAT 106101 is read out.

When a target file and/or management information thereof is managed using the virtual address, the VAT 106101 obtained in step S11106 is used for making reference to the VAT entry to which file entry of the target file and/or directory is registered (step S11107).

A conversion process from the virtual address to the logical address is performed. Then, with having the file set descriptor 10421 in the file structure/file area 10420 as an origin, the FE (ROOT) 10604 in the file structure/file area 10600, ROOT directory included in the FE (ROOT) 10604, the FE (Dir-A) 10503 in the file structure/file area 10500, directory (Dir-A) included in the FE (Dir-A) 10503 and the FE (File-a) 10502 are sequentially read out.

The recording location of the data file (File-a) 10501 is obtained from the FE (File-a) 10502, and the reproduction of the data file (File-a) 10501 is performed.

A method for incremental recording to the DVD-R dicks using the VAT method has been described above. However, the multiborder method is also known as an incremental recording method different from the VAT method. A similar method when used in the CD-R dicks is called a multisession method.

In the multiborder method, data is incrementally recorded with a bordered area as a unit, and the volume structure and the file structure are recorded for each bordered area.

In the multiborder method, a system of updating data using the virtual address such as VAT is not used. When the file structure is updated, the volume structure and the file structure are newly generated and re-recorded in a new bordered area.

Reproduction using the multiborder method determines the latest bordered area and reads out the latest volume structure therefrom.

Thereafter, a specific file can be reproduced in order by tracing data in accordance with the data structure defined by the UDF specification. For example, data can be read out with a reproduction procedure similar to that for read-only disks like DVD-ROM.

Further, when the multiborder/multisession method is used, efficient data recording using the image data is performed. When all the files which are desired for recording are known, for example, when taking a backup of data, the data for all files which is desired to be recorded on a hard click drive and a file including all the volume structure and file structure thereof are created. The file is image data. For recording the image data, one bordered area (or a session) is allocated, and the image data is continuously recorded in the area. Since recording is performed continuously, and the file structure has been already created, overhead at the time of recording becomes small. Thus, recording of the image data can be performed at a high speed.

Reference 1: U.S. Pat. No. 5,666,531

### DISCLOSURE OF THE INVENTION

However, in the VAT method described above, information of a file structure (FE or directory file) is dispersed and recorded in a plurality of areas of an information recording medium. Thus, there is a problem that a large amount of process time is required for tracing a directory structure, accessing and reading out data from a particular file (see Reference 1).

For example, as described with reference to FIG. 17, in order to reproduce a data file (File-a) 10501, it is necessary to access and read out data from areas, such as a file structure/file area 10420, a file structure/file area 10500, a file structure/file area 10600 and a VAT structure area 106100.

The present invention is intended to solve the problems described above. The objective of the present invention is to provide: an information recording medium capable of accessing a data file at a high speed even when an efficient incremental file recording is performed by the VAT method; an information recording method and an information recording apparatus for recording information on the information recording medium; and an information reproducing method and an information reproducing apparatus for reproducing the information recorded on the information recording medium.

A recording apparatus according to the present invention is a recording apparatus for recording information on a write-once recording medium, the write-once recording medium including a disk management information area and a volume space, the recording apparatus including: a host apparatus; and a drive apparatus, the host apparatus including: a first instruction section for instructing the drive apparatus to allocate at least one first track and at least one second track to the volume space; a second instruction section for instructing the drive apparatus to record a file on the at least one first track; a third instruction section for instructing the drive apparatus to record a file structure on the at least one second track, the file structure managing the file; a fourth instruction section for instructing the drive apparatus to record a virtual allocation table structure in the volume space, the virtual allocation table structure managing a recording location of the file structure; and a fifth instruction section for instructing the drive apparatus to record track management information in the disk management information area, the track management information managing the at least one first track and the at least one second track, the drive apparatus including: a head section for allocating the at least one first track and the at least one second track to the volume space, recording the file on the at least one first track, recording the file structure on the at least one second track, recording the virtual allocation table structure in the volume space and recording the track management information in the disk management information area; and a control section for controlling the head section so as to allocate the at least one first track and the at least one second track to the volume space, record the file on the at least one first track, record the file structure on the at least one second track, record the virtual allocation table structure in the volume space and record the track management information in the disk management information area, thereby the objective described above being achieved.

The control section may control the head section so as to record the virtual allocation table structure in an area subsequent to a last recorded location of the file of the at least one first track.

The third instruction section may further instruct the drive apparatus to record predetermined information on the at least one second track, and the control section may control the head section so as to record the predetermined information of the file structure on the at least one second track.

A host apparatus according to the present invention is a host apparatus included in a recording apparatus for recording information on a write-once recording medium, the write-once recording medium including a disk management information area and a volume space, the recording apparatus further including: a drive apparatus for recording the information on the write-once recording medium, the host apparatus including: a first instruction section for instructing the drive apparatus to allocate at least one first track and at least one second track to the volume space; a second instruction section for instructing the drive apparatus to record a file on the at least one first track; a third instruction section for instructing the drive apparatus to record a file structure on the at least one second track, the file structure managing the file; a fourth instruction section for instructing the drive apparatus to record a virtual allocation table structure in the volume space, the virtual allocation table structure managing a recording location of the file structure; and a fifth instruction section for instructing the drive apparatus to record track management information in the disk management information area, the track management information managing the at least one first track and the at least one second track, thereby the objective described above being achieved.

The third instruction section may further instruct the drive apparatus to record predetermined information of the file structure on the at least one second track.

A recording method according to the present invention is a recording method for recording information on a write-once recording medium, the write-once recording medium including a disk management information area and a volume space, the recording method including: a first instruction step of instructing to allocate at least one first track and at least one second track to the volume space; an allocation step of allocating the at least one first track and the at least one second track to the volume space; a second instruction step of instructing to record a file on the at least one first track; a first recording step of recording the file on the at least one first track; a third instruction step of instructing to record a file structure on the at least one second track, the file structure managing the file; a second recording step of recording the file structure on the at least one second track; a fourth instruction section of instructing to record a virtual allocation table structure in the volume space, the virtual allocation table structure managing a recording location of the file structure; a third recording step of recording the virtual allocation table structure in the volume space; a fifth instruction section of instructing to record track management information in the disk management information area, the track management information managing the at least one first track and the at least one second track; and a fourth recording step of recording the track management information in the disk management information area, thereby the objective described above being achieved.

An instruction method according to the present invention is an instruction method executed by a host apparatus included in a recording apparatus for recording information on a write-once recording medium, the write-once recording medium including a disk management information area and a volume space, the instruction method including: a first instruction step of instructing to allocate at least one first track and at least one second track to the volume space; a second instruction step of instructing to record a file on the at least one first track; a third instruction step of instructing to record a file structure on the at least one second track, the file structure managing the file; a fourth instruction step of instructing to record a virtual allocation table structure in the volume space, the virtual allocation table structure managing a recording location of the file structure; and a fifth instruction step of instructing to record track management information in the disk management information area, the track management information managing the at least one first track and the at least one second track, thereby the objective described above being achieved.

A program according to the present invention is a program for executing a recording procedure by a recording apparatus for recording information on a write-once recording medium, the write-once recording medium including a disk management information area and a volume space, the recording procedure including: a first instruction step of instructing to allocate at least one first track and at least one second track to the volume space; an allocation step of allocating the at least one first track and the at least one second track to the volume space; a second instruction step of instructing to record a file on the at least one first track; a first recording step of recording the file on the at least one first track; a third instruction step of instructing to record a file structure on the at least one second track, the file structure managing the file; a second recording step of recording the file structure on the at least one second track; a fourth instruction step of instructing to record a virtual allocation table structure in the volume space, the virtual allocation table structure managing a recording location of the file structure; a third recording step of recording the virtual allocation table structure in the volume space; a fifth instruction step of instructing to record track management information in the disk management information area, the track management information managing the at least one first track and the at least one second track; and a fourth recording step of recording the track management information in the disk management information area, thereby the objective described above being achieved.

A program according to the present invention is a program for executing an instruction procedure by a host apparatus included in a recording apparatus for recording information on a write-once recording medium, the write-once recording medium including a disk management information area and a volume space, the instruction procedure including: a first instruction step of instructing to allocate at least one first track and at least one second track to the volume space; a second instruction step of instructing to record a file on the at least one first track; a third instruction step of instructing to record a file structure on the at least one second track, the file structure managing the file; a fourth instruction step of instructing to record a virtual allocation table structure in the volume space, the virtual allocation table structure managing a recording location of the file structure; and a fifth instruction step of instructing to record track management information in the disk management information area, the track management information managing the at least one first track and the at least one second track, thereby the objective described above being achieved.

An integrated circuit according to the present invention is an integrated circuit included in a recording apparatus for recording information on a write-once recording medium, the write-once recording medium including a disk management information area and a volume space, the recording apparatus further including: a drive apparatus for recording the information on the write-once recording medium, the integrated circuit including: a first instruction section for instructing the drive apparatus to allocate at least one first track and at least one second track to the volume space; a second instruction section for instructing the drive apparatus to record a file on the at least one first track; a third instruction section for instructing the drive apparatus to record a file structure on the at least one second track, the file structure managing the file; a fourth instruction section for instructing the drive apparatus to record a virtual allocation table structure in the volume space, the virtual allocation table structure managing a recording location of the file structure; and a fifth instruction section for instructing the drive apparatus to record track management information in the disk management information area, the track management information managing the at least one first track and the at least one second track, thereby the objective described above being achieved.

A reproduction apparatus according to the present invention is a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction apparatus including: a host apparatus; and a drive apparatus, the host apparatus including a first instruction section for instructing the drive apparatus to reproduce the track management information from the disk management information area; a second instruction section for instructing the drive apparatus to reproduce the virtual allocation table structure from the volume space based on the track management information; a third instruction section for instructing the drive apparatus to reproduce the file structure from the at least one second track; and a fourth instruction section for instructing the drive apparatus to reproduce the file from the at least one first track, the drive apparatus including a head section for reproducing the track management information from the disk management information area, reproducing the virtual allocation table structure from the volume space, reproducing the file structure from the at least one second track and reproducing the file from the at least one first track; and a control section for controlling the head section so as to reproduce the track management information from the disk management information area, reproduce the virtual allocation table structure from the volume space, reproduce the file structure from the at least one second track and reproduce the file from the at least one first track, thereby the objective described above being achieved.

The virtual allocation table structure may be recorded in an area subsequent to a last recorded location of the file of the at least one first track; and the second instruction section may instruct the drive apparatus to reproduce the virtual allocation table structure from the area subsequent to the last recorded location of the file.

Predetermined information of the file structure may be further recorded on the at least one second track, and the third instruction section may instruct the drive apparatus to reproduce the predetermined information from the at least one second track.

A host apparatus according to the present invention is a host apparatus included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction apparatus further including: a drive apparatus for reproducing the information from the write-once recording apparatus, the host apparatus including, a first instruction section for instructing the drive apparatus to reproduce the track management information from the disk management information area; a second instruction section for instructing the drive apparatus to reproduce the virtual allocation table structure from the volume space based on the track management information; a third instruction section for instructing the drive apparatus to reproduce the file structure from the at least one second track; and a fourth section for instructing the drive apparatus to reproduce the file from the at least one first track, thereby the objective described above being achieved.

Predetermined information of the file structure may be further recorded on the at least one second track, and the third instruction section may instruct the drive apparatus to reproduce the predetermined information from the at least one second track.

A reproduction method according to the present invention is reproduction method for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction method including: a first instruction step of instructing to reproduce the track management information from the disk management information area; a first reproduction step of reproducing the track management information from the disk management information area; a second instruction step of instructing to reproduce the virtual allocation table structure from the volume space based on the track management information; a second reproduction step of reproducing the virtual allocation table structure from the volume space; a third instruction step of instructing to reproduce the file structure from the at least one second track; a third reproduction step of reproducing the file structure from the at least one second track; a fourth instruction step of instructing to reproduce the file from the at least one first track; and a fourth reproduction step of reproducing the file from the at least one first track, thereby the objective described above being achieved.

An instruction method according to the present invention is an instruction method executed by a host apparatus included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the instruction method including: a first instruction step of instructing to reproduce the track management information from the disk management information area; a second instruction step of instructing to reproduce the virtual allocation table structure from the volume space based on the track management information; a third instruction step of instructing to reproduce the file structure from the at least one second track; and a fourth step of instructing to reproduce the file from the at least one first track, thereby the objective described above being achieved.

A program according to the present invention is a program for executing a reproduction procedure by a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction procedure including: a first instruction step of instructing to reproduce the track management information from the disk management information area; a first reproduction step of reproducing the track management information from the disk management information area; a second instruction step of instructing to reproduce the virtual allocation table structure from the volume space based on the track management information; a second reproduction step of reproducing the virtual allocation table structure from the volume space; a third instruction step of instructing to reproduce the file structure from the at least one second track; a third reproduction step of reproducing the file structure from the at least one second track; a fourth instruction step of instructing to reproduce the file from the at least one first track; a fourth reproduction step of reproducing the file from the at least one first track, thereby the objective described above being achieved.

A program according to the present invention is a program for executing an instruction procedure by a host apparatus included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the instruction procedure including: a first instruction step of instructing to reproduce the track management information from the disk management information area; a second instruction step of instructing to reproduce the virtual allocation table structure from the volume space based on the track management information; a third instruction step of instructing to reproduce the file structure from the at least one second track; and a fourth step of instructing to reproduce the file from the at least one first track, thereby the objective described above being achieved.

An integrated circuit according to the present invention is an integrated circuit included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction apparatus further including: a drive apparatus for reproducing the information from the write-once recording medium, the integrated circuit including a first instruction section for instructing the drive apparatus to reproduce the track management information from the disk management information area; a second instruction section for instructing the drive apparatus to reproduce the virtual allocation table structure from the volume space based on the track management information; a third instruction section for instructing the drive apparatus to reproduce the file structure from the at least one second track; and a fourth section for instructing the drive apparatus to reproduce the file from the at least one first track, thereby the objective described above being achieved.

A write-once recording medium according to the present invention is a write-once recording medium structured so as to record information thereon, the write-once recording medium including: a disk management information area; and a volume space, the volume space is structured such that the at least one first track and the at least one second track are allocated to the volume space; the at least one first track is structured so such that a file is recorded on the at least one first track; the at least one second track is structured so such that a file structure which manages the file is recorded on the at least one second track; the volume space is structured such that a virtual allocation table structure which manages a recording location of the file structure is recorded on the volume space; and the disk management information area is structured such that track management information which manages the at least one first track and the at least one second track is recorded in the disk management information area, thereby the objective described above being achieved.

According to the present invention, tracks are allocated to a volume space, and a file structure is recorded on a particular track. Therefore, it is possible to reduce the amount of access frequency, thereby a high speed access to the file structure being realized.

According to the present invention, it is possible to improve the reliability of an information recording medium by performing a recording of duplication of the file structure.

### BRIEF DESCRIPTION OF THE DRAWINGS

FIG. 1A is a view showing an appearance of a write-once recording medium 100 according to Embodiment 1 of the present invention.

FIG. 1B is a view showing an example of a data structure of data recorded on the write-one recording medium 100 according to Embodiment 1 of the present invention.

FIG. 1C is a view showing a diagram showing the detail of a user area 108.

FIG. 2A is a view showing a data structure of the session management information 200.

FIG. 2B is a view showing a data structure of one of the plurality of track management information 210.

FIG. 3 is a view showing an example of a data structure of the write-once recording medium 100.

FIG. 4 is a view showing another example of a data structure of the write-once recording medium 100.

FIG. 5 is a view showing another example of a data structure of the write-once recording medium 100.

FIG. 6 is a view showing another example of a data structure of the write-once recording medium 100.

FIG. 7 is a view showing an information recording/reproduction apparatus 300 according to the embodiment of the present invention.

FIG. 8 is a flowchart showing a format procedure according to the embodiment of the present invention.

FIG. 9 is a flowchart showing a recording procedure according to the embodiment of the present invention.

FIG. 10 is a flowchart showing a reproduction procedure according to Embodiment 1 of the present invention.

FIG. 11 is a view showing an example of a data structure of the write-once recording medium 100.

FIG. 12 is a view showing another example of a data structure of the write-once recording medium 100.

FIG. 13 is a view showing a file and directory tree structure.

FIG. 14 is a view showing data on a DVD-R click immediately after a format process is performed wherein the DVD-R click is an example of a conventional information recording medium 10100.

FIG. 15 is a view for describing a procedure of recording a directory (Dir-A) and a data file (File-a) of a file and directory structure.

FIG. 16 is a view for describing a recording procedure for a directory (Dir-B) and a data file (File-b) of the file and directory structure.

FIG. 17 is a flowchart showing a reproduction procedure.

100 information recording medium
101 lead-in area
102 data area
103 lead-out area
104 first disk management information area
105 second disk management information area
300 recording/reproduction apparatus
301 system control section
302 first memory circuit
303 I/O bus
304 magnetic click apparatus
305 host apparatus
310 drive apparatus
311 drive control section
312 second memory circuit
313 internal bus
314 recording/reproduction section

### BEST MODE FOR CARRYING OUT THE INVENTION

Hereinafter, embodiments of the present invention will be described with reference to the accompanying drawings.

### 1. Embodiment 1

1-1. Write-Once Recording Medium

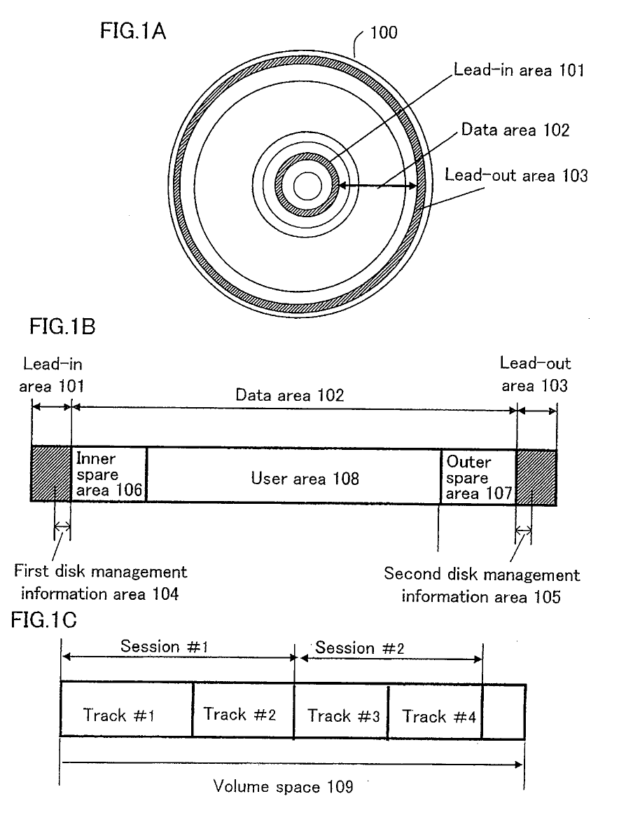

FIG. 1 shows a write-once recording medium 100 according to Embodiment 1 of the present invention.

FIG. 1A shows an appearance of the write-once recording medium 100 according to Embodiment 1 of the present invention. In the write-once recording medium 100, a lead-in area 101 is allocated in an inner-most periphery of the write-once recording medium 100, a lead-out area 103 is allocated in an outer-most periphery of the write-one recording medium 100, and a data area 102 is allocated between the lead-in area 101 and the lead-out area 103. The lead-in area 101, the data area 102 and the lead-out area 103 are concentric.

In the lead-in area 101, for example, reference information necessary for an optical pickup to access the write-once recording medium 100, and information for identifying between the write-one recording medium 100 and other write-once recording media are recorded. In the lead-out area 103, information similar to that in the lead-in area 101 is recorded.

The data area 102 is separated into sectors, i.e., the smallest units for access. Data is recorded or reproduced with ECC blocks (or, ECC clusters) including a plurality of sectors as the smallest units.

FIG. 1B shows an example of a data structure of data recorded on the write-one recording medium according to Embodiment 1 of the present invention. In FIG. 1B, the lead-in area 101, the data area 102 and the lead-out area 103 are shown in the lateral direction in the figure.

The lead-in area 101 includes a first disk management information area 104. The lead-out area 103 includes a second disk management information area 105. Disk management information (e.g., replacement information, session management information, track management information and unrecorded area management information) is recorded in each of the first management information area 104 and the second disk management information area 105. The replacement information includes, for example, information of original location before replacement indicating a location of an original location to be replaced (defective sector (or defective ECC block) and information of replacing location indicating a location after replacement. The track management information will be described later in detail.

The data area 102 includes an inner spare area 106, an outer spare area 107 and a user area 108. When there is a defective area in the user area 108, at least portions of the inner spare area 106 and the outer spare area 107 are used to replace the defective area. For example, when there is a defective sector in the user area 108, at least portions of the inner spare area 106 and the outer spare area 107 are used as replacement sectors. In the at least some portions of the inner spare area 106 and the outer spare area 107, information related to the information recorded in the user area 108 is recorded.

In at least one of the inner spare area 106 and the outer spare area 107, an additional disk management information area may be provided. In the additional disk management information area, disk management information is recorded.

FIG. 1C shows the detail of the user area 108. At least one session (e.g., session #1 and session #2) is allocated to the user area 108. The at least one session is managed by making reference to session management information. At least one track is allocated to each of the at least one session. For example, track #1 and track #2 are allocated to the session #1, and track #3 and track #4 are allocated to the session #2. The start location and the last recorded area of each of the at least one track are managed by making reference to track management information.

Management of user data to be recorded in the user area 108 is performed by making reference to a file system. A space to be managed by making reference to the file system is called a volume space 109.

In the description to be made below, a volume/file structure making up the file system is defined, for example, by ISO/IEC13346 standard or UDF (Universal Disk Format) specification.

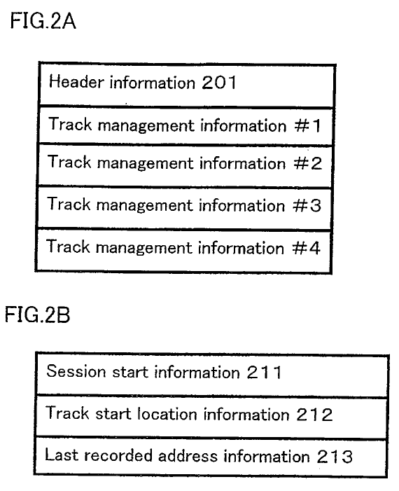

FIG. 2 shows a data structure of information to be recorded in the disk management information area (see FIG. 1B). Disk management information is recorded in the disk management information area. The disk management information includes replacement information, session management information 200, track management information 210 and unrecorded area management information 220.

FIG. 2A shows a data structure of the session management information 200. The session management information 200 includes header information 201 and a plurality of track management information (track management information #1, #2, #3, #4). The header information 201 includes an identifier for the session management information 200 and information 202 indicating the number of the plurality of track management information 210. The header information 201 includes, for example, information indicating a track number of a recordable track (recordable track numbers 203, 204). The information indicating the track number of the track having a state where data cannot be recorded (i.e., non-recordable track or closed track) for some reason (e.g., because there is no unrecorded area or due to an instruction from a user) is not included in the header information 201. The plurality of track management information (track management information #1, #2, #3, #4) correspond to a plurality of tracks (tracks #1, #2, #3, #4) (see FIG. 1C), respectively.

FIG. 2B shows a data structure of one of the plurality of track management information 210. The track management information 210 includes: session start information 211 indicating whether a corresponding track is a leading track of the session; track start location information 212 indicating a start location of the track; and last recorded address information 213 indicating a location at which data has been recoded last within the track.

If a track managed by the track management information 210 is located at a leading position of the session, information having a value indicating such (e.g., “1”) is set to the session start information 211. If a track managed by the track management information is not located at a leading position of the session, information having a different value (e.g., “0”) is set to the session start information 211.

The track start location information 212 is, for example, a physical address showing a start location of a corresponding track.

The last recorded address information 213 is, for example, a last recorded physical address indicating a location at which data has been recorded last in the corresponding track. It is possible to recognize an empty area on the information recording medium 100 by checking the recordable track number and the last recoded address information 213.

In the present embodiment, it is possible to record data for each track. The data recording is performed from a leading position of each of a plurality of tracks. The data is continuously allocated within the track. Once the data has been recorded, the last recorded address information 213 is updated to indicate the last recorded address.

When the data recording is performed next time, the latest value of the last recorded address information 213 is checked. As a result, it is possible to recognize the next recording start location. In general, the next recording start location is a physical sector which is next to the physical sector indicated by the last recorded address information 213. Alternatively, when the data recording is made as a minimum unit of ECC block with respect to the information recording medium 100, the next recording start location may be within an ECC block which is next to the ECC block including the physical sector indicated by the last recorded address information 213.

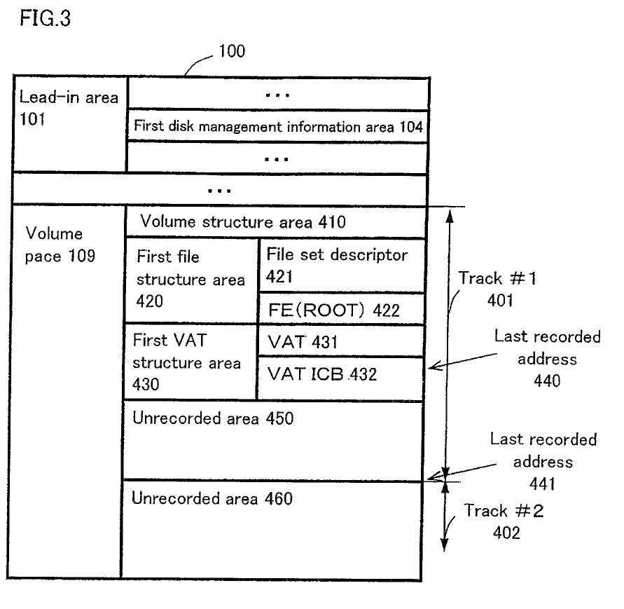

FIG. 3 shows an example of a data structure of the write-once recording medium 100. In FIG. 3, the same reference numbers are denoted to the areas which have been described with reference to FIG. 1, and the description thereof will be omitted.

Track #1 401 and track #2 402 are allocated to the volume space 109.

The track #1 401 includes: a volume structure area 410 where a volume structure is recorded; a first file structure area 420 where a file structure is recorded; a first VAT structure area 430 where a VAT structure is recorded; and an unrecorded area 450. When a format procedure is performed, the volume structure is recorded in the volume structure area 410, the file structure (e.g., file set descriptor 421, FE (ROOT) 442) is recorded in the first file structure area 420 and the VAT structure (e.g., VAT 431, VAT ICB 432) is recorded in the first VAT structure area 430. The format procedure will be described later in detail.

The VAT structure (virtual allocation table structure) includes a VAT (virtual allocation table) and a VAT ICB. The VAT structure manages a recording location of the file structure. The VAT is defined by the UDF specification for the purpose of simplifying a process of updating process the file structure in the write-once recording medium. The VAT holds a correspondence between a logical address, which is a recording location in a logical address space on the information recording medium, and the virtual address. When the VAT is used, a recording location of the file structure data such as FE in the volume space is specified using virtual address in a virtual address space. The recording location of the VAT is specified by VAT ICB to be allocated to a last sector of an area in which data has been recorded.

With the VAT structure, data can be rewritten virtually even on an information recording medium which is not rewritable, such as a DVD-R disk.

The boundary between the first VAT structure area 430 and the unrecorded area 450 is a last recorded address 440. Information indicating the last recorded address 440 is recorded as track management information in the first disk management information area 104.

The track #2 402 includes an unrecorded area 460. When a recording procedure for a data file is performed, the data file is recorded in the unrecorded area 460, and a file structure which manages the recorded data file is recorded in the unrecorded area 450. The recording procedure for the data file will be described later in detail.

The boundary between the unrecorded area 450 and the unrecorded area 460 is a last recorded address 441. Information indicating the last recorded address 441 is recorded as track management information in the first disk management information area 104.

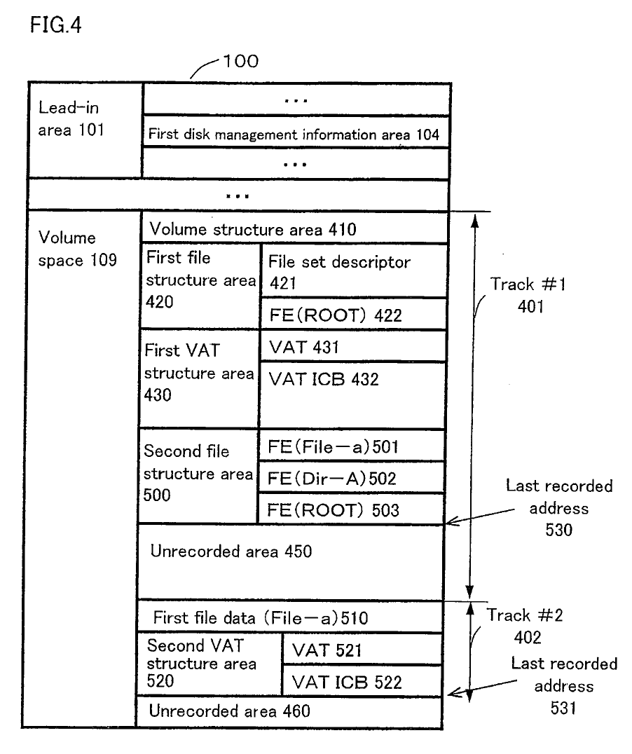

FIG. 4 shows another example of a data structure of the write-once recording medium 100. In FIG. 4, the same reference numbers are denoted to the areas which have been described with reference to FIGS. 1 and 3, and the description thereof will be omitted. Further, in FIG. 4, the same reference numbers are denoted to the information and data which have been described with reference to FIGS. 1 and 3, and the description thereof will be omitted. The write-once recording medium 100 having the data structure, which will be described with reference to FIG. 4, is created by performing a recording procedure for files (specifically, first data file (File-a) 510) for the write-one recording medium 100 having the data structure, which has been described with reference to FIG. 3.

The track #1 401 further includes a second file structure area 500 where a file structure is recorded. When the recording procedure for the first data file (File-a) 510 is performed, the file structure (e.g., FE (File-a) 501, FE (Dir-A) 502 and FE (ROOT) 503 indicating a recording location of the first data file (File-a) 510) is recorded in the second file structure area 500.

The boundary between the second file structure area 500 and the unrecorded area 450 is a last recorded address 530. Information indicating the last recorded address 530 is recorded as track management information in the first disk management information area 104.

The track #2 402 further includes the first data file (File-a) 510 and a second VAT structure area 520. When the recording procedure for the first data file (File-a) 510 is performed, the first data file (File-a) 510 is recorded in the unrecorded area 460, a file structure (FE (File-a) 501, FE (Dir-A) 502 and FE (ROOT) 503) which manages the first data file (File-a) 510 is recorded in the second file structure area 500, and VAT 521 and VAT ICB 522 are recorded in the second VAT structure area 520.

The boundary between the second VAT structure area 520 and the unrecorded area 460 is a last recorded address 531. Information indicating the last recorded address 531 is recorded as track management information in the first disk management information area 104.

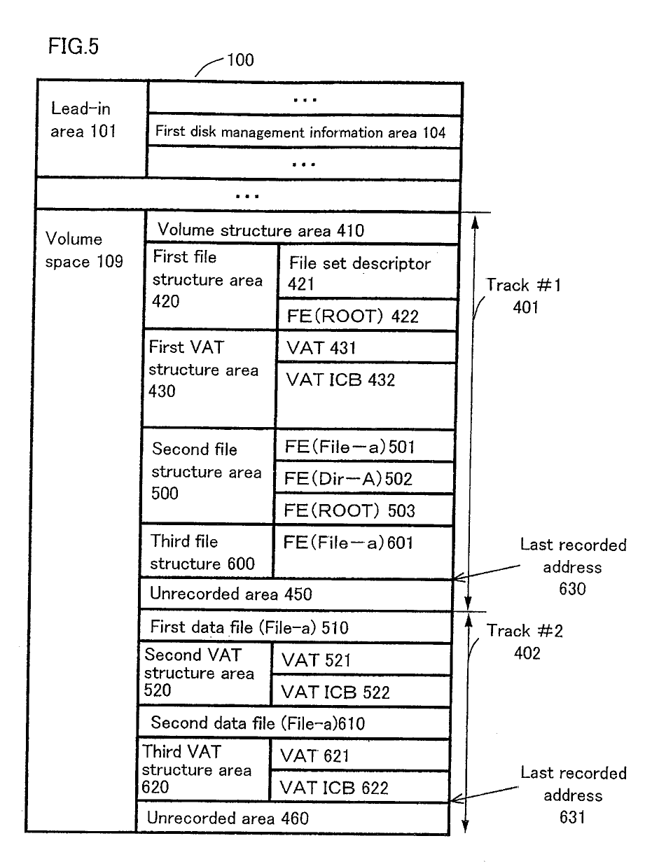

FIG. 5 shows another example of a data structure of the write-once recording medium 100. In FIG. 5, the same reference numbers are denoted to the areas which have been described with reference to FIGS. 1, 3 and 4, and the description thereof will be omitted. Further, in FIG. 5, the same reference numbers are denoted to the information and data which have been described with reference to FIGS. 1, 3 and 4, and the description thereof will be omitted. The write-once recording medium 100 having the data structure, which will be described with reference to FIG. 5, is created by performing the recording procedure for files for the write-one recording medium 100 having the data structure, which has been described with reference to FIG. 4 and rewriting the first data file (File-a) 510 into the second data file (File-a) 610.

The track #1 401 further includes a third file structure area 600 where a file structure is recorded. When a recording procedure for the second data file (File-a) 610 is performed, a file structure (e.g., FE (File-a) 601 indicating a recording location of the second data file (File-a) 610) is recorded in the third file structure area 600.

The boundary between the third structure area 600 and the unrecorded area 450 is a last recorded address 630. Information indicating the last recorded address 630 is recorded as track management information in the first disk management information area 104.

The track #2 402 further includes the second data file (File-a) 610 and a third VAT structure area 620. When the recording procedure for the second data file (File-a) 610 is performed, the second data file (File-a) 610 is recorded in the unrecorded area 460, a file structure (FE (File-a) 601 which manages the second data file (File-a) 610 is recorded in the third file structure area 600, and VAT 621 and VAT ICB 622 are recorded in the third VAT structure area 620.

The boundary between the third VAT structure area 620 and the unrecorded area 460 is a last recorded address 631. Information indicating the last recorded address 631 is recorded as track management information in the first disk management information area 104.

As described with reference to FIG. 5, when the recording procedure for files is performed on the write-once recording medium 100, it is possible to incrementally record files on the write-once recording medium 100. Files are incrementally recorded in accordance with the recording procedure for files and then, it becomes impossible to record a file structure in the track #1 401 since there is no unrecorded area 450 left. In the case where there is no unrecorded area 450 left, by allocating a new track to the unrecorded area 460, it is possible to record a file and a file structure.

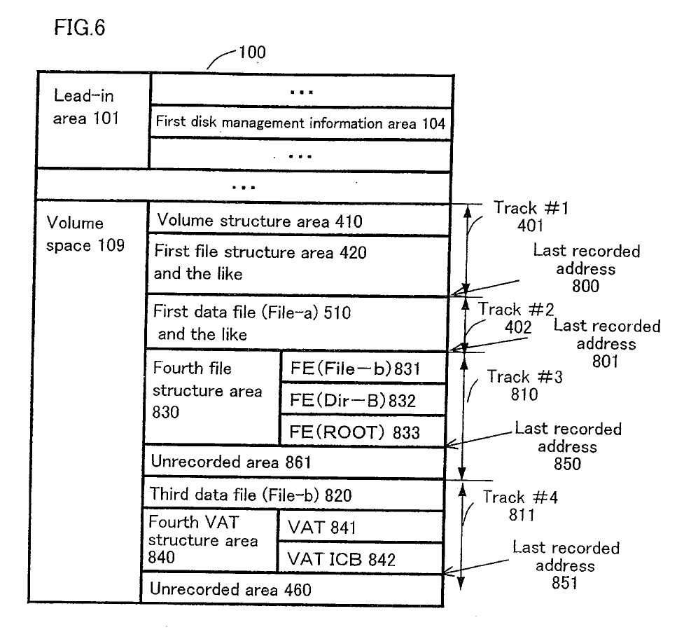

FIG. 6 shows another example of a data structure of the write-once recording medium 100. In FIG. 6, the same reference numbers are denoted to the areas which have been described with reference to FIGS. 1, 3, 4 and 5, and the description thereof will be omitted. Further, in FIG. 6, the same reference numbers are denoted to the information and data which have been described with reference to FIGS. 1, 3, 4 and 5, and the description thereof will be omitted. The write-once recording medium 100 having the data structure, which will be described with reference to FIG. 6, is created by allocating track #3 810 and track #4 811 to the unrecorded area 460 of the write-one recording medium 100 having the data structure, which has been described with reference to FIG. 5 and performing the recording procedure for the third data file (File-b) 820.

The volume space 109 includes the track #1 401, the track #2 402, the track #3 810 and the track #4 811.

The track #1 401 does not include an unrecorded area. The reason for this is that a file structure and a VAT structure area are allocated to the entire track #1 401. The boundary between the track #1 401 and the track #2 402 is a last recorded address 800. Information indicating the last recorded address 800 is recorded as track management information in the first disk management information area 104.

The track #2 402 does not include an unrecorded area. The reason for this is that the track #2 402 is closed due to allocation of the track #3 810. The boundary between the track #2 402 and the track #3 810 is a last recorded address 801. Information indicating the last recorded address 801 is recorded as track management information in the first disk management information area 104.

The track #3 810 includes: a fourth file structure area 830 where a file structure is recorded; and an unrecorded area 861. When a recording procedure for the third data file (File-b) 820 is performed, a file structure (e.g., FE (File-b) 831, FE (Dir-B) 832 and FE (ROOT) 833 indicating a recording location of the third data file (File-b) 820) is recorded in the fourth file structure area 830.

The boundary between the fourth structure area 830 and the unrecorded area 861 is a last recorded address 850. Information indicating the last recorded address 850 is recorded as track management information in the first disk management information area 104.

The track #4 811 further includes the third data file (File-b) 820, a fourth VAT structure area 840 and an unrecorded area 460. When the recording procedure for the third data file (File-b) 820 is performed, the third data file (File-b) 820 is recorded in the track #4 811, a file structure (FE (File-b) 831) which manages the third data file (File-b) 820 is recorded in the fourth file structure area 830, and VAT 841 and VAT ICB 842 are recorded in the fourth VAT structure area 840.

The boundary between the fourth VAT structure area 840 and the unrecorded area 460 is a last recorded address 851. Information indicating the last recorded address 851 is recorded as track management information in the first disk management information area 104.

A closing procedure may be performed for the write-once recording medium 100 having the data structure shown in FIG. 6. Furthermore, when an additional recording of further files is prohibited from being performed on the write-once recording medium 100 having the data structure recorded thereon shown in FIG. 6, a lead-out area may be allocated to the unrecorded area 460.

1-2. Information Recording/Reproduction Apparatus

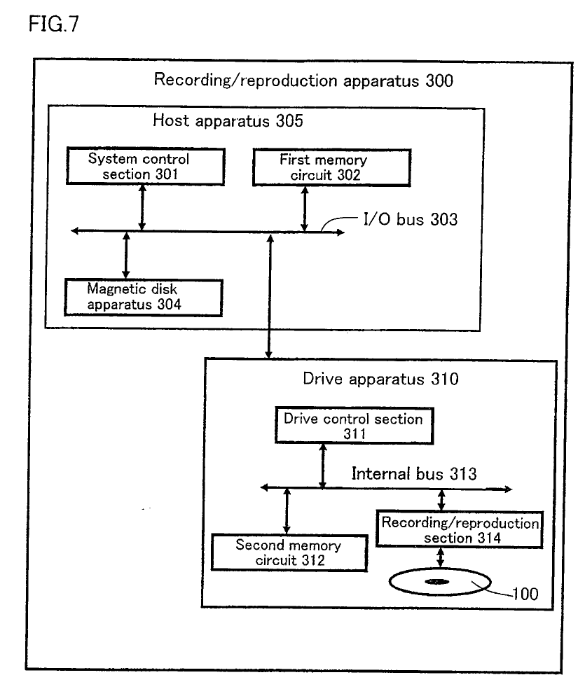

FIG. 7 shows an information recording/reproduction apparatus 300 according to the embodiment of the present invention. The information recording/reproduction apparatus 300 includes a host apparatus 305 and a drive apparatus 310. The host apparatus 305 may be, for example, a computer system or a personal computer. The information recording/reproduction apparatus 300 functions as one of a recording apparatus, a reproduction apparatus and a recording/reproduction apparatus.

The host apparatus 305 includes a system control section 301, a first memory circuit 302, a magnetic click apparatus 304 and an I/O bus 303. Data is transferred between the host apparatus 305 and the write-once recording medium 100 via the drive apparatus 310.

The system control section 301 controls the first memory circuit 302 and the magnetic disk apparatus 304. For example, the system control section 301 controls the first memory circuit 302 such that the first memory circuit 302 transfers data to both the magnetic disk apparatus 304 and the drive apparatus 310.

The system control section includes a microprocessor which includes a memory for computation and performs a system control program. For example, the system control section 301 performs recording/reproduction of a volume structure/file structure of a file system, recording/reproduction of a VAT structure, recording/reproduction of a file and recording/reproduction of data for a lead-in/lead-out area.

For example, the system control section 301 instructs the drive apparatus 310 to allocate a plurality of tracks to the volume space 109. Further, the system control section 301 instructs the drive apparatus 310 to record a file on one of the plurality of tracks. Furthermore, the system control section 301 instructs the drive apparatus 310 to record a file structure, which manages the file, one of the plurality of tracks. Yet further, the system control section 301 instructs the drive apparatus 310 to record a virtual allocation table structure, which manages a recording location of the file structure, on the volume space 109. Yet further, the system control section 301 instructs the drive apparatus 310 to record track management information, which manages the plurality of tracks, on a first disk management information area 104.

Moreover, for example, the system control section 301 instructs the drive apparatus 310 to reproduce the track management information, which manages the plurality of tracks, from the disk management information area. Further, the system control section 301 instructs the drive apparatus 310 to reproduce the virtual allocation table structure from the volume space 109, based on the track management information. Furthermore, the system control section 301 instructs the drive apparatus 310 to reproduce the file structure from the one of the plurality of tracks. Yet further, the system control section 301 instructs the drive apparatus 310 to reproduce the file from the one of the plurality of tracks.

The first memory circuit 302 is used to compute or temporarily store the volume structure, the file structure, the VAT structure and the file.

The drive apparatus 310 includes a drive control section 311, a second memory circuit 312, an internal bus 313 and a recording/reproduction section 314. The recording/reproduction section 314 may be, for example, a head section. The drive apparatus 310 is structured so as to be able to mount the write-once recording medium 100 thereon. The drive apparatus 310 transfers data between the drive apparatus 310 and the write-once recording medium 100.

The drive control section 311 includes a microprocessor which includes a memory for computation and performs a drive control program. The drive control section 311 performs a controlling for the process on recording/reproduction of data for the click management information area and the spare area, pseudo overwrite recording/reproduction; and performs a computation. The drive control section 311 controls the second memory circuit 312 and the recording/reproduction section 314. For example, the drive control section 311 controls the second memory circuit 312 and the recording/reproduction section 314 such that the second memory circuit 312 and the recording/reproduction section 314 record information on the write-once recording medium 100 and further, the second memory circuit 312 and the recording/reproduction section 314 reproduce the information from the write-once recording medium 100.

The system control section 301 and the drive control section 311 may be realized an integrated circuit such as an LSI. Alternatively, they can be realized by a general processor and a memory (e.g., ROM). In the memory (e.g., ROM), a program executable by a computer (e.g., general processor) is stored. This program represents a format procedure, a recording procedure for files, a closing procedure and a reproduction procedure according to the present invention. The computer (e.g., general computer) executes these procedures in accordance with this program.

1-3. Recording Procedure

1-3-1. Format Procedure

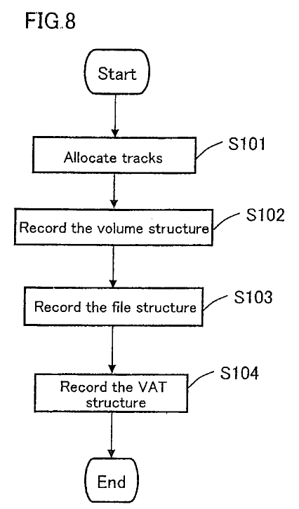

FIG. 8 show a format procedure according to the embodiment of the present invention. When the recording/reproduction apparatus 300, which has been described with reference to FIG. 7, performs the format procedure, the recording/reproduction apparatus 300 can create the write-once recording medium 100 having the data structure shown in FIG. 3.

Hereinafter, the format procedure according to the embodiment of the present invention will be described step by step with reference to FIGS. 3, 7 and 8.

Step S101: The system control section 301 of the host apparatus 305 instructs the drive apparatus 310 to allocate tracks to the user area 108. The drive apparatus 310 allocates the tracks to the user area 108.

Specifically, the system control section 301 instructs the allocation of track #1 401 and track #2 402. The drive apparatus 310 controls the head section 314 so as to allocate the track #1 401 and the track #2 402 to the user area 108.

Step S102: The system control section 301 creates a volume structure in the first memory circuit 302 and instructs the drive apparatus 310 to record the created volume structure in the volume structure area 410. The drive apparatus 310 records the volume structure, which has been transferred from the first memory circuit 302, in the volume structure area 410.

The volume structure conforms to the VAT method defined by the ISO/IEC 13346 standard and the UDF specification. The volume structure includes, for example a descriptor for holding management information of the volume space 109.

Step S103: The system control section 301 creates a file structure in the first memory circuit 302 and instructs the drive apparatus 310 to record the created file structure in the file structure area 420. The file structure includes a file set descriptor 421, a ROOT directory and FE (ROOT) 422 which manages the ROOT directory.

The drive apparatus 310 records the file structure, which has been transferred from the first memory circuit 302, in the file structure area 420.

Step S104: The system control section 301 creates a VAT structure in the first memory circuit 302 and instructs the drive apparatus 310 to record the created VAT structure in the first VAT structure area 430. The VAT structure includes VAT 431 and VAT ICB 432.

The drive apparatus 310 records the VAT structure, which has been transferred from the first memory circuit 302, in the first VAT structure area 430.

After the VAT structure is recorded in the first VAT structure area 430, the process is completed.

It is preferable that the leading location of the track (e.g., track #1 401) where the file structure is recorded corresponds to the ECC block and the length of the track where the file structure is recorded has a length of integer multiplication of the ECC block. The reason for this is that a recording unit of data and a logical structure are unique and thus, it is possible to perform an efficient data access.

1-3-2. Recording Procedure for Files

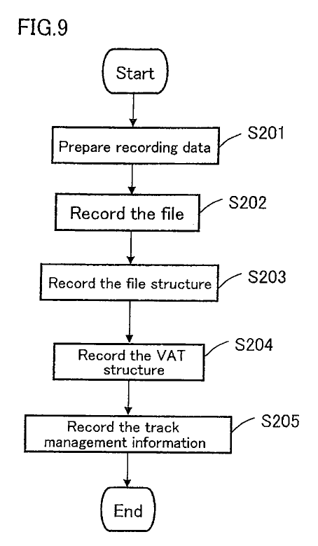

FIG. 9 shows a recording procedure for files according to the embodiment of the present invention. When the recording/reproduction apparatus 300, which has been described with reference to FIG. 7, performs the recording procedure for files, a file is recorded on the write-once recording medium 100 having the data structure shown in FIG. 3 and then, the write-once recording medium 100 having the data structure shown in FIG. 4 is created.

Hereinafter, the recording procedure for files according to the embodiment of the present invention will be described step by step with reference to FIGS. 3, 4, 7 and 9.

Step S201: The system control section 301 of the host apparatus 305 prepares recording data.

Specifically, the system control section 301 reads out a first data file (File-a) 510, which is stored in the magnetic disk apparatus 304, from the magnetic disk apparatus 304 and transfers the first data file (File-a) 510 to the first memory circuit 302. Further, the system control section 301 creates a directory file (Dir-A), FE (File-a) 501 and FE (Dir-A) 502 in the first memory circuit 302. Furthermore, the system control section 301 further creates an updated FE (ROOT) 503 in the first memory circuit 302 since the contents of the ROOT directory are updated in accordance with the addition of the directory file (Dir-A).

Step S202: The system control section 301 instructs the drive apparatus 310 to record the first data file (File-a) 510 on the track #2 402.

The drive apparatus 310 controls the head section 314 so as to record the first data file (File-a) 510, which has been transferred from the first memory circuit 302, on the track #2 402.

Step S203: The system control section 301 instructs the drive apparatus 310 to record the file structure (FE (File-a) 501, FE (Dir-A) 502, FE (ROOT) 503) on the track #2 402.

The drive apparatus 310 controls the head section 314 so as to record the file structure, which has been transferred from the first memory circuit 302, on the track #2 402.

Step S204: The system control section 301 creates a VAT structure in the first memory circuit 302 and instructs the drive apparatus 310 to record the created VAT structure in second VAT structure area 520. The VAT structure includes VAT 521 and the VAT ICB 522.

The drive apparatus 310 controls the head section 314 so as to record the VAT structure, which has been transferred from the first memory circuit 302, at a location immediately after the recording location of the first data file (File-a) 510. The VAT ICB 522 is stored in accordance with a definition (of UDF specification) that is arranged at the rearmost recording location of the write-one recording medium 100.

Step S205: The drive apparatus 310 controls the head section 314 so as to record the track management information in the first disk management information area 104.

The system control section 301 may instruct the drive apparatus 310 to record information indicating the last recorded address 531 as track management information in the first disk management information area 104.

After the track management information is recorded, the process is completed.

With reference to FIGS. 3, 4, 7 and 9, the recording procedure for files according to the embodiment of the present invention has been described.

When the recording/reproduction apparatus 300 performs the recording procedure for files, the second data file (File-a) is recorded on the write-once recording medium 100 having the data structure shown in FIG. 4 and then, the write-once recording medium 100 having the data structure shown in FIG. 5 is created.

1-4. Reproduction Procedure

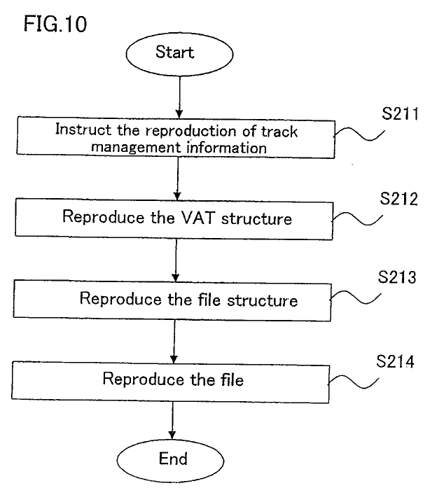

FIG. 10 show a reproduction procedure according to Embodiment 1 of the present invention.

Hereinafter, the reproduction procedure according to Embodiment 1 of the present invention will be described step by step with reference to FIGS. 2, 4, 7 and 10.

When the steps which will be described below are performed, the recording/reproduction apparatus 300 reproduces the first data file (File-a) 510 from the write-once recording medium 100 having the data structure which has been described with reference to FIG. 4.

Step S211: The system control section 301 of the host apparatus 305 instructs the drive apparatus 310 to reproduce the track management information recorded in the first disk management information area 104 in order to obtain information indicating the last recorded address 531. The drive apparatus 310 controls the head section 314 so as to reproduce the track management information.

Step S212: The system control section 301 instructs the drive apparatus 310 to reproduce the VAT ICB 522 based on the information of the last recorded address 531, which has been obtained from the reproduced track management information. The drive apparatus 310 controls the head section 314 so as to reproduce the VAT ICB 522. Further, the drive apparatus 310 controls the head section 314 so as to reproduce the information of the recording location of the VAT 521 based on the reproduced VAT ICB 522.

Step S213: The system control section 301 makes reference to the VAT 521 and instructs the drive apparatus 310 to reproduce the second file structure 500 and the first data file (File-a) 510.

The drive apparatus 310 controls the head section 314 so as to reproduce the second file structure 500 and the first data file (File-a) 510.

Specifically, when a target file and/or management information thereof is managed using a virtual address, then the VAT 521 is referred to, and a conversion from the virtual address to a logical address is performed. With the file set descriptor 421 as an origin, the FE (ROOT) 503, the ROOT directory included in the FE (ROOT) 503, the FE (Dir-A) 502, the directory (Dir-A) included in FE (Dir-A) 502 and the FE (File-a) 501 are sequentially read out.

Step S214: The system control section 301 instructs the drive apparatus 310 to reproduce the first data file (File-a) 510. A recording location of the first data file (File-a) 510 is obtained from the FE (File-a) 501. The drive apparatus controls the head section 314 so as to reproduce the first data file (File-a) 510.

After the first data file (File-a) 510 is reproduced, the process is completed.

Since the track where the file structure is recorded is recognized, data may be continuously read out and stored in the first memory circuit 302 and then, a data structure may be analyzed. As a result, it is possible to perform an efficient data access a high speed.

In order to perform the reproduction procedure more easily, information indicating the type of data, which is recorded in a corresponding track, may be added to the track management information 210. For example, in accordance with the instruction from the system control section 301, an identifier or flag indicating if the track is a track for recording the file structure may be recorded. As a result, it is possible to perform an efficient data access by the drive apparatus 310.

### 2. Embodiment 2

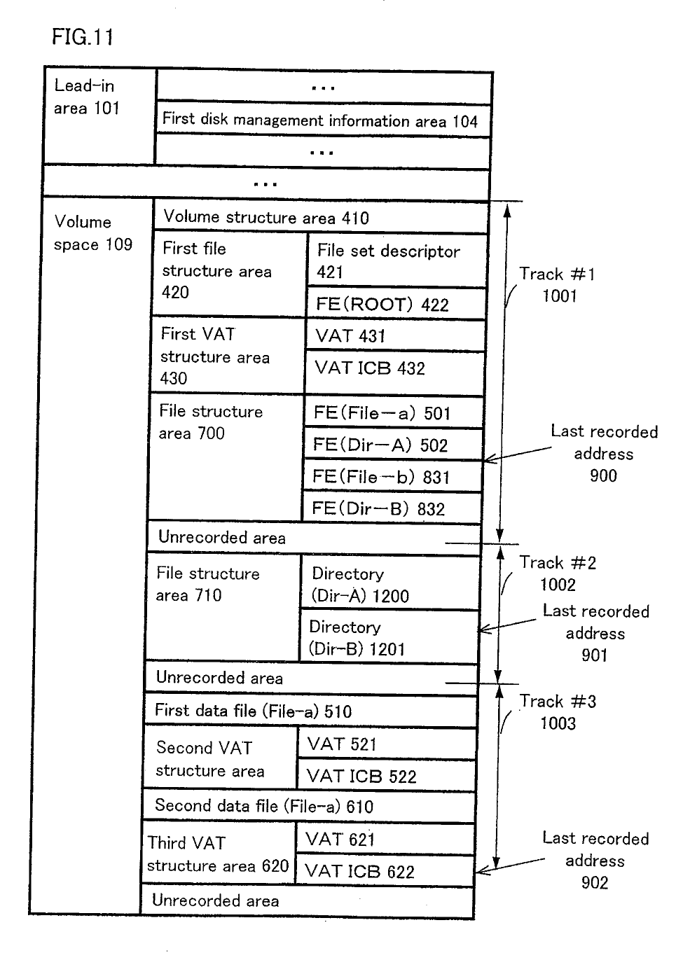

FIG. 11 is an example of a data structure of the write-once recording medium 100. In FIG. 11, the same reference numbers are denoted to the areas which have been described with reference to FIGS. 1, 3, 4, 5 and 6, and the description thereof will be omitted. Further, in FIG. 11, the same reference numbers are denoted to the information and data which have been described with reference to FIGS. 1, 3, 4, 5 and 6, and the description thereof will be omitted.

According to Embodiment 2 of the present invention, in the write-once recording medium 100, a track is allocated for each file structure (FE and directory file (data including FID which is defined by the UDF specification).

Track #1 1001, track #2 1002 and track #3 1003 are allocated to the volume space 109.

The track #1 1001 includes: a volume structure area 410 where a volume structure is recorded; a first file structure area 420 where a file structure is recorded; a first VAT structure area 430 where a VAT structure is recorded; a file structure area 700 where a file structure (FE) is recorded; and an unrecorded area. When the recording procedure (see “1-3-2. Recording procedure for files”) of the file (first data file (File-a) 510 and second data file (File-a) 610) is performed, then the volume structure is recorded in the volume structure area 410, the file structure (file set descriptor 421 and FE (ROOT) 422) is recorded in the first file structure area 420, the VAT structure (VAT 431 and VAT ICB 432) is recorded in the first VAT structure area 430, and the file structure (FE (File-a) 501, FE (Dir-A) 502, FE (File-b) 831, FE (Dir-B) 832) is recorded in the file structure area 700.

The boundary between the file structure area 700 and the unrecorded area is a last recorded address 900. Information indicating the last recorded address 900 is recorded as track management information in the first disk management information area 104.

The track #2 1002 includes a file structure area 710 where a file structure (directory) is recorded and an unrecorded area. When the recording procedure (see “1-3-2. Recording procedure for files”) of the file (first data file (File-a) 510 and second data file (File-a) 610) is performed, then a file structure (directory (Dir-A) 1200 and directory (Dir-B) 1201) is recorded in the file structure area 710.

The boundary between the file structure area 710 and the unrecorded area is a last recorded address 901. Information indicating the last recorded address 901 is recorded as track management information in the first disk management information area 104.

The track #3 1003 includes a first data file (File-a) 510, a second VAT structure area 520, a second data file (File-a) 610, a third VAT structure area 620 and an unrecorded area. When the recording procedure (see “1-3-2. Recording procedure for files”) of the file (first data file (File-a) 510 and second data file (File-a) 610) is performed, then the first data file (File-a) 510 is recorded in the track #3, and VAT 521 and VAT ICB 522 are recorded in the second VAT structure area 520. Further, the second data file (File-a) 610 is recorded in the track #3 1003, and the VAT 621 and the VAT ICB 622 are recorded in the third VAT structure area 620. In the write-once recording medium 100 having the data structure shown in FIG. 11, the VAT 621 and the VAT ICB 622 are the latest VAT structure.

The boundary between the third VAT structure area 620 and the unrecorded area is a last recorded address 902. Information indicating the last recorded address 902 is recorded as track management information in the first disk management information area 104.

According to Embodiment 2 of the present invention, it is possible to perform an efficient access when reading out particular information (e.g., only FE) among the file structures recorded on the write-once recording medium 100. Especially, in the case of a VAT method, the FEs are address-managed by the VATs, which is advantageous in realizing the VAT method.

Tracks may be allocated in view of a directory tree. For example, a directory tree, which records data for a particular application (e.g., TV program recording) is determined and then a file or a directory under a predetermined directory may be allocated to a track. As a result, it is possible perform an efficient data access.

### 3. Embodiment 3

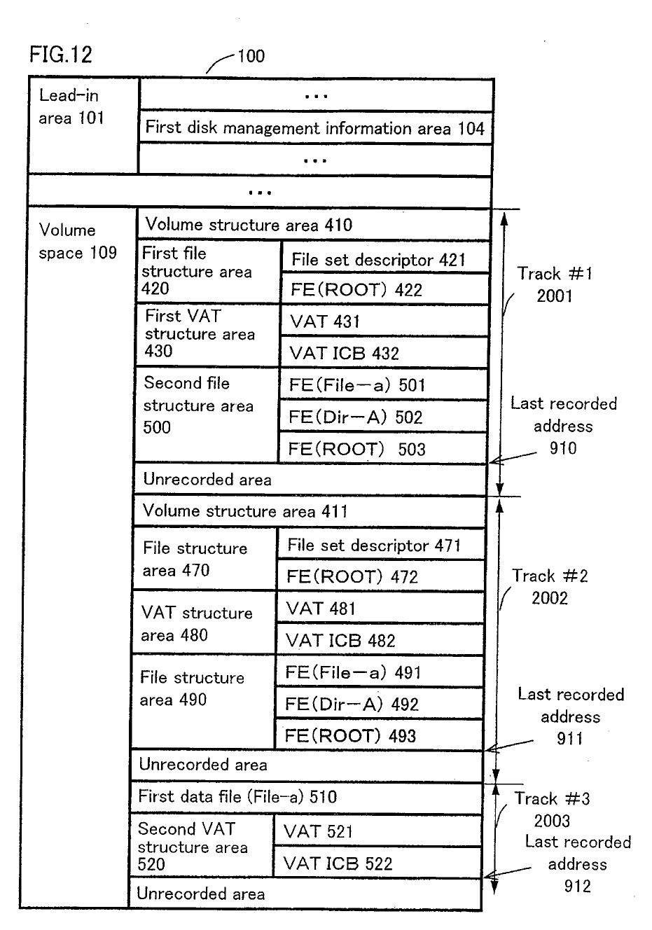

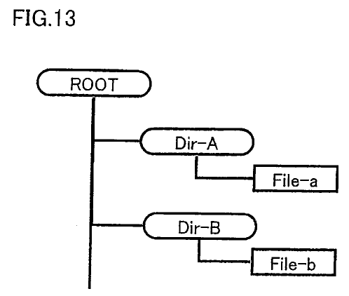

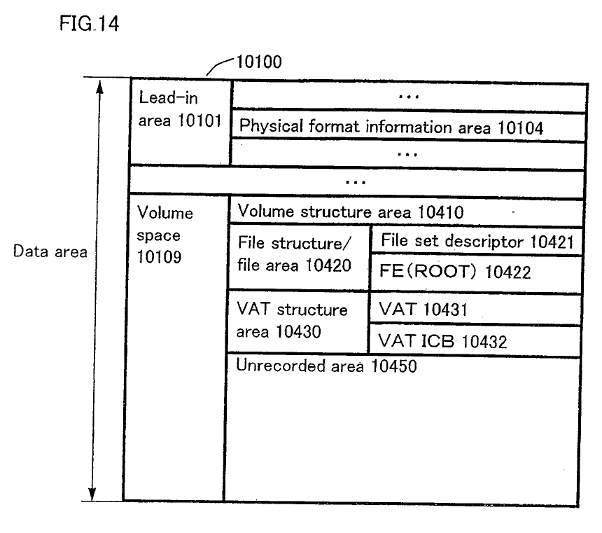

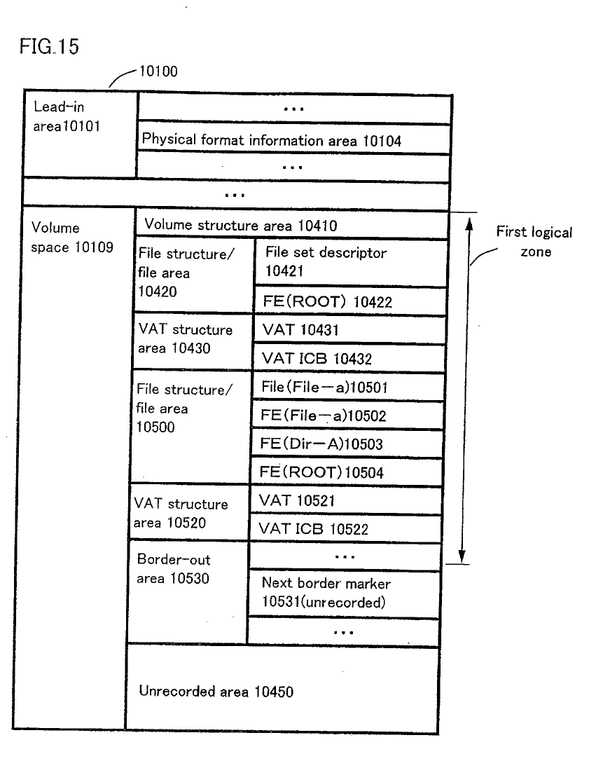

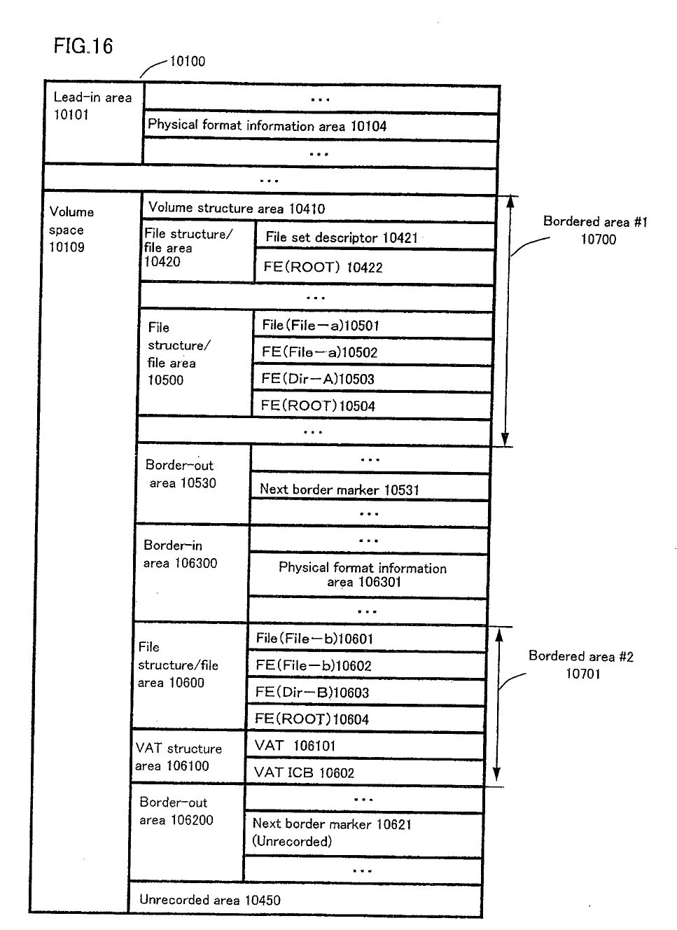

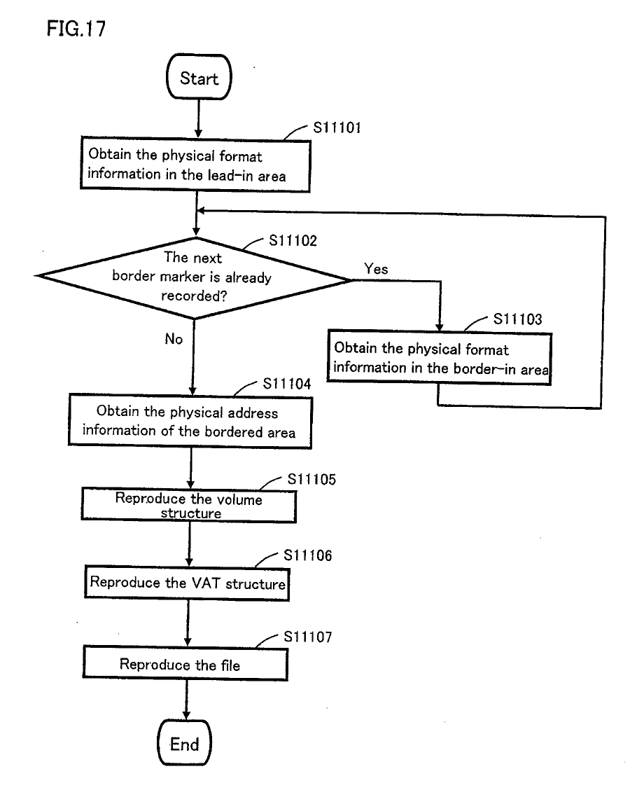

FIG. 12 is another example of a data structure of the write-once recording medium 100. In FIG. 12, the same reference numbers are denoted to the areas which have been described with reference to FIGS. 1, 3 and 4, and the description thereof will be omitted. Further, in FIG. 12, the same reference numbers are denoted to the information and data which have been described with reference to FIGS. 1, 3 and 4, and the description thereof will be omitted.

According to Embodiment 3 of the present invention, the same file structure is recorded in a plurality of tracks of the write-once recording medium 100.

Track #1 2001, track #2 2002 and track #3 2003 are allocated to the volume space 109.

The track #1 2001 includes: a volume structure area 410 where a volume structure is recorded; a first file structure area 420 where a file structure is recorded; a first VAT structure area 430 where a VAT structure is recorded; a second file structure area 500 where a file structure is recorded; and an unrecorded area. When the format procedure (see “1-3-1. Format procedure”) of the file (first data file (File-a) 510 and second data file (File-a) 610) is performed, then the volume structure is recorded in the volume structure area 410, the file structure (file set descriptor 421 and FE (ROOT) 422) is recorded in the first file structure area 420, the VAT structure (VAT 431 and VAT ICB 432) is recorded in the first VAT structure area 430, and the file structure (e.g., FE (File-a) 501), FE (Dir-A) 502, FE (ROOT) 503 indicating a recording location of the first data file (File-a) 510) is recorded in the second file structure area 500.

The boundary between the second file structure area 500 and the unrecorded area is a last recorded address 910. Information indicating the last recorded address 910 is recorded as track management information in the first disk management information area 104.

The track #2 2002 includes: a volume structure area 411 where a volume structure is recorded; a file structure area 470 where a file structure is recorded; a VAT structure area 480 where a VAT structure is recorded; a file structure area 490 where a file structure is recorded; and an unrecorded area. This can be realized when the system control section 301 instructs the drive apparatus 310 to record duplication of the file structures and the duplication of the VAT structure, which were recorded in the track #1 2001, on the track #2 after the format procedure (see “1-3-1. Format procedure”) of the recording procedure for files (first data file (File-a) 510 and second data file (File-a) 610) (see “1-3-2. Recording procedure for files”) is performed.

Duplication of the volume structure is recorded in the volume structure area 411, the duplication (file set descriptor 471 and FE (ROOT) 472) of the file structure (file set descriptor 421 and FE (ROOT) 422) is recorded in the file structure area 470, the duplication (VAT 481 and VAT ICB 482) of the VAT structure (VAT 431 and VAT ICB 432) is recorded in the VAT structure area 480, and the duplication (FE (File-a) 491, FE (Dir-A) 492, FE (ROOT) 493 indicating a recording location of the first data file (File-a) 510) of the file structure (FE (File-a) 501, FE (Dir-A) 502, FE (ROOT) 503 indicating a recording location of the first data file (File-a) 510) is recorded in the file structure area 490.

The drive apparatus 310 which is instructed to perform a recording on the track #1 2001 may automatically record the duplication of data (volume structure, file structure, VAT structure) on the track #2 2002. Each time the drive apparatus 310 is instructed to perform recording on the track #1 2001, the drive apparatus 310 may automatically record the duplication on the track #2 2002. When the drive apparatus 310 is instructed by the system control section 301 to record the duplication, the drive apparatus 310 may record the duplication on the track #1 2001.

The boundary between the file structure area 490 and the unrecorded area is a last recorded address 911. Information indicating the last recorded address 911 is recorded as track management information in the first disk management information area 104.

The track #3 2003 includes a first data file (File-a) 510, a second VAT structure area 520 and an unrecorded area. When the recording procedure for the first data file (File-a) 510 is performed, then the first data file (File-a) 510 recorded in the unrecorded area, the file structure (FE (File-a) 501, FE (Dir-A) 502, FE (ROOT) 503) which manages the first data file (File-a) 510 is recorded in the second file structure area 500, and the VAT 521 and the VAT ICB 522 are recorded in the second VAT structure area 520.

The boundary between the second VAT structure area 520 and the unrecorded area is a last recorded address 912. Information indicating the last recorded address 912 is recorded as track management information in the first disk management information area 104.

When the reproduction procedure (see “1-4. Reproduction procedure”) is performed, it is possible to reproduce data recorded in the track #1 2001. However, when it is not possible to reproduce the data from the track #1 2001 (e.g., when there is a scratch on the track #1 2001), data may be reproduced from the track #2 2002. Accordingly, it is possible to use the data in the track #2 2002 as a backup for the data in the track #1 2001. As a result, the reliability of the write-once recording medium 100 is improved.

A file structure to be recorded in the track #2 2002 can be that as recorded in the track #1 2001. However, in such a case, a logical address for a file structure area and a logical address which is practically recorded are different from each other. In this case, when data is reproduced by utilizing the file structure to be recorded on the track #2 2002, conversion of the address may be performed. When the file structure is recorded in the track #2 2002, there is no need for performing an address conversion at the time of reproduction if the directory tree is maintained and only the logical address is converted and recorded.

Embodiment 3 according to the present invention only describes one latest VAT structure. For improving the reliability of the write-once recording medium 100, duplication of the VAT structure itself may be recorded. In this case, a VAT structure for the file structure to be recorded in the track #2 may be recorded, for example, at a location immediately before the second VAT structure area 520. The entire file structure to be recorded in the track #2 2002 may be regarded as an extended attribute file of VAT ICB. As a result, high compatibility with the UDF specification can be achieved.

Relationship information between tracks may be recorded as additional information in the track management information 210. As a result, it is possible to easily determine that duplication of data recorded in a predetermined track is recorded in a different track. For example, additional information indicating that information recorded in the track #2 2002 is duplication of information recorded in the track #1 2001 may be recorded in the track management information, which manages the information recorded in the track #1 2001. Alternatively, additional information indicating that information recorded in the track #2 2002 is duplication of information recorded in the track #1 2001, may be recorded in the track management information, which manages the information recorded in the track #2 2002.

### INDUSTRIAL APPLICABILITY

According to the present invention, tracks are allocated to a volume space, and a file structure is recorded on a particular track. Therefore, it is possible to reduce the amount of access frequency, thereby a high speed access to the file structure being realized.

Further, according to the present invention, it is possible to improve the reliability of an information recording medium by performing a recording of duplication of the file structure.

1. A recording apparatus for recording information on a write-once recording medium, the write-once recording medium including a disk management information area and a volume space, the recording apparatus comprising:
a host apparatus; and
a drive apparatus,
the host apparatus including:
a first instruction section for instructing the drive apparatus to allocate at least one first track and at least one second track to the volume space;
a second instruction section for instructing the drive apparatus to record a file on the at least one first track;
a third instruction section for instructing the drive apparatus to record a file structure on the at least one second track, the file structure managing the file;
a fourth instruction section for instructing the drive apparatus to record a virtual allocation table structure in the volume space, the virtual allocation table structure managing a recording location of the file structure; and
a fifth instruction section for instructing the drive apparatus to record track management information in the disk management information area, the track management information managing the at least one first track and the at least one second track,
the drive apparatus including:
a head section for allocating the at least one first track and the at least one second track to the volume space, recording the file on the at least one first track, recording the file structure on the at least one second track, recording the virtual allocation table structure in the volume space and recording the track management information in the disk management information area; and
a control section for controlling the head section so as to allocate the at least one first track and the at least one second track to the volume space, record the file on the at least one first track, record the file structure on the at least one second track, record the virtual allocation table structure in the volume space and record the track management information in the disk management information area.

2. A recording apparatus according to claim 1, wherein the control section controls the head section so as to record the virtual allocation table structure in an area subsequent to a last recorded location of the file of the at least one first track.

3. A recording apparatus according to claim 1, wherein the third instruction section further instructs the drive apparatus to record predetermined information on the at least one second track, and
the control section controls the head section so as to record the predetermined information of the file structure on the at least one second track.

4. A host apparatus included in a recording apparatus for recording information on a write-once recording medium, the write-once recording medium including a disk management information area and a volume space, the recording apparatus further including:
a drive apparatus for recording the information on the write-once recording medium,
the host apparatus including:
a first instruction section for instructing the drive apparatus to allocate at least one first track and at least one second track to the volume space;
a second instruction section for instructing the drive apparatus to record a file on the at least one first track;
a third instruction section for instructing the drive apparatus to record a file structure on the at least one second track, the file structure managing the file;
a fourth instruction section for instructing the drive apparatus to record a virtual allocation table structure in the volume space, the virtual allocation table structure managing a recording location of the file structure; and
a fifth instruction section for instructing the drive apparatus to record track management information in the disk management information area, the track management information managing the at least one first track and the at least one second track.

5. A recording apparatus according to claim 4, wherein the third instruction section further instructs the drive apparatus to record predetermined information of the file structure on the at least one second track.

6. A recording method for recording information on a write-once recording medium, the write-once recording medium including a disk management information area and a volume space, the recording method comprising:
a first instruction step of instructing to allocate at least one first track and at least one second track to the volume space;
an allocation step of allocating the at least one first track and the at least one second track to the volume space;
a second instruction step of instructing to record a file on the at least one first track;
a first recording step of recording the file on the at least one first track;
a third instruction step of instructing to record a file structure on the at least one second track, the file structure managing the file;
a second recording step of recording the file structure on the at least one second track;
a fourth instruction section of instructing to record a virtual allocation table structure in the volume space, the virtual allocation table structure managing a recording location of the file structure;
a third recording step of recording the virtual allocation table structure in the volume space;
a fifth instruction section of instructing to record track management information in the disk management information area, the track management information managing the at least one first track and the at least one second track; and
a fourth recording step of recording the track management information in the disk management information area.

7. An instruction method executed by a host apparatus included in a recording apparatus for recording information on a write-once recording medium, the write-once recording medium including a disk management information area and a volume space, the instruction method comprising:
a first instruction step of instructing to allocate at least one first track and at least one second track to the volume space;
a second instruction step of instructing to record a file on the at least one first track;
a third instruction step of instructing to record a file structure on the at least one second track, the file structure managing the file;
a fourth instruction step of instructing to record a virtual allocation table structure in the volume space, the virtual allocation table structure managing a recording location of the file structure; and
a fifth instruction step of instructing to record track management information in the disk management information area, the track management information managing the at least one first track and the at least one second track.

8. A program for executing a recording procedure by a recording apparatus for recording information on a write-once recording medium, the write-once recording medium including a disk management information area and a volume space, the recording procedure including:
a first instruction step of instructing to allocate at least one first track and at least one second track to the volume space;
an allocation step of allocating the at least one first track and the at least one second track to the volume space;
a second instruction step of instructing to record a file on the at least one first track;
a first recording step of recording the file on the at least one first track;
a third instruction step of instructing to record a file structure on the at least one second track, the file structure managing the file;
a second recording step of recording the file structure on the at least one second track;
a fourth instruction step of instructing to record a virtual allocation table structure in the volume space, the virtual allocation table structure managing a recording location of the file structure;
a third recording step of recording the virtual allocation table structure in the volume space;
a fifth instruction step of instructing to record track management information in the disk management information area, the track management information managing the at least one first track and the at least one second track; and
a fourth recording step of recording the track management information in the disk management information area.

9. A program for executing an instruction procedure by a host apparatus included in a recording apparatus for recording information on a write-once recording medium, the write-once recording medium including a disk management information area and a volume space, the instruction procedure including:
a first instruction step of instructing to allocate at least one first track and at least one second track to the volume space;
a second instruction step of instructing to record a file on the at least one first track;
a third instruction step of instructing to record a file structure on the at least one second track, the file structure managing the file;
a fourth instruction step of instructing to record a virtual allocation table structure in the volume space, the virtual allocation table structure managing a recording location of the file structure; and
a fifth instruction step of instructing to record track management information in the disk management information area, the track management information managing the at least one first track and the at least one second track.

10. An integrated circuit included in a recording apparatus for recording information on a write-once recording medium, the write-once recording medium including a disk management information area and a volume space, the recording apparatus further including:
a drive apparatus for recording the information on the write-once recording medium,
the integrated circuit including:
a first instruction section for instructing the drive apparatus to allocate at least one first track and at least one second track to the volume space;
a second instruction section for instructing the drive apparatus to record a file on the at least one first track;
a third instruction section for instructing the drive apparatus to record a file structure on the at least one second track, the file structure managing the file;
a fourth instruction section for instructing the drive apparatus to record a virtual allocation table structure in the volume space, the virtual allocation table structure managing a recording location of the file structure; and
a fifth instruction section for instructing the drive apparatus to record track management information in the disk management information area, the track management information managing the at least one first track and the at least one second track.

11. A reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction apparatus comprising:
a host apparatus; and
a drive apparatus,
the host apparatus including
a first instruction section for instructing the drive apparatus to reproduce the track management information from the disk management information area;
a second instruction section for instructing the drive apparatus to reproduce the virtual allocation table structure from the volume space based on the track management information;
a third instruction section for instructing the drive apparatus to reproduce the file structure from the at least one second track; and
a fourth instruction section for instructing the drive apparatus to reproduce the file from the at least one first track,
the drive apparatus including
a head section for reproducing the track management information from the disk management information area, reproducing the virtual allocation table structure from the volume space, reproducing the file structure from the at least one second track and reproducing the file from the at least one first track; and
a control section for controlling the head section so as to reproduce the track management information from the disk management information area, reproduce the virtual allocation table structure from the volume space, reproduce the file structure from the at least one second track and reproduce the file from the at least one first track.

12. A reproduction apparatus according to claim 11, wherein the virtual allocation table structure is recorded in an area subsequent to a last recorded location of the file of the at least one first track; and
the second instruction section instructs the drive apparatus to reproduce the virtual allocation table structure from the area subsequent to the last recorded location of the file.

13. A reproduction apparatus according to claim 11, wherein predetermined information of the file structure is further recorded on the at least one second track, and
the third instruction section instructs the drive apparatus to reproduce the predetermined information from the at least one second track.

14. A host apparatus included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction apparatus further including:
a drive apparatus for reproducing the information from the write-once recording apparatus,
the host apparatus including,
a first instruction section for instructing the drive apparatus to reproduce the track management information from the disk management information area;
a second instruction section for instructing the drive apparatus to reproduce the virtual allocation table structure from the volume space based on the track management information;
a third instruction section for instructing the drive apparatus to reproduce the file structure from the at least one second track; and
a fourth section for instructing the drive apparatus to reproduce the file from the at least one first track.

15. A reproduction apparatus according to claim 14, wherein predetermined information of the file structure is further recorded on the at least one second track, and
the third instruction section instructs the drive apparatus to reproduce the predetermined information from the at least one second track.

16. A reproduction method for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction method comprising:
a first instruction step of instructing to reproduce the track management information from the disk management information area;
a first reproduction step of reproducing the track management information from the disk management information area;
a second instruction step of instructing to reproduce the virtual allocation table structure from the volume space based on the track management information;
a second reproduction step of reproducing the virtual allocation table structure from the volume space;
a third instruction step of instructing to reproduce the file structure from the at least one second track;
a third reproduction step of reproducing the file structure from the at least one second track;
a fourth instruction step of instructing to reproduce the file from the at least one first track; and
a fourth reproduction step of reproducing the file from the at least one first track.

17. An instruction method executed by a host apparatus included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the instruction method comprising:
a first instruction step of instructing to reproduce the track management information from the disk management information area;
a second instruction step of instructing to reproduce the virtual allocation table structure from the volume space based on the track management information;
a third instruction step of instructing to reproduce the file structure from the at least one second track; and
a fourth step of instructing to reproduce the file from the at least one first track.

18. A program for executing a reproduction procedure by a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction procedure including:
a first instruction step of instructing to reproduce the track management information from the disk management information area;
a first reproduction step of reproducing the track management information from the disk management information area;
a second instruction step of instructing to reproduce the virtual allocation table structure from the volume space based on the track management information;
a second reproduction step of reproducing the virtual allocation table structure from the volume space;
a third instruction step of instructing to reproduce the file structure from the at least one second track;
a third reproduction step of reproducing the file structure from the at least one second track;
a fourth instruction step of instructing to reproduce the file from the at least one first track;
a fourth reproduction step of reproducing the file from the at least one first track.

19. A program for executing an instruction procedure by a host apparatus included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the instruction procedure including:
a first instruction step of instructing to reproduce the track management information from the disk management information area;
a second instruction step of instructing to reproduce the virtual allocation table structure from the volume space based on the track management information;
a third instruction step of instructing to reproduce the file structure from the at least one second track; and
a fourth step of instructing to reproduce the file from the at least one first track.

20. An integrated circuit included in a reproduction apparatus for reproducing information from a write-once recording medium, the write-once recording medium including a disk management information area and a volume space, at least one first track and at least one second track being allocated to the volume space, a file being recorded on the at least one first track, a file structure which manages the file being recorded on the at least one second track, a virtual allocation table structure which manages a recording location of the file structure being recorded in the volume space, and track management information which manages the at least one first track and the at least one second track being recorded in the disk management information area, the reproduction apparatus further including:
a drive apparatus for reproducing the information from the write-once recording medium,
the integrated circuit including
a first instruction section for instructing the drive apparatus to reproduce the track management information from the disk management information area;
a second instruction section for instructing the drive apparatus to reproduce the virtual allocation table structure from the volume space based on the track management information;
a third instruction section for instructing the drive apparatus to reproduce the file structure from the at least one second track; and
a fourth section for instructing the drive apparatus to reproduce the file from the at least one first track.

21. A write-once recording medium structured so as to record information thereon, the write-once recording medium comprising:
a disk management information area; and
a volume space,
the volume space is structured such that the at least one first track and the at least one second track are allocated to the volume space;
the at least one first track is structured so such that a file is recorded on the at least one first track;
the at least one second track is structured so such that a file structure which manages the file is recorded on the at least one second track;
the volume space is structured such that a virtual allocation table structure which manages a recording location of the file structure is recorded on the volume space; and
the disk management information area is structured such that track management information which manages the at least one first track and the at least one second track is recorded in the disk management information area.
